(19) United States
(12) Patent Application Publication
(10) Pub. No.: US 2005/0031805 A1
(43) Pub. Date: Feb. 10, 2005

(54) Pigment selection for photographic base stock

(76) Inventors: Gary P. Fugitt, Chillicothe, OH (US); Dean R. Johnson, Columbia, MD (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/870,676

(22) Filed: Jun. 17, 2004

Related U.S. Application Data
(60) Provisional application No. 60/478,991, filed on Jun. 17, 2003.
(60) Provisional application No. 60/479,119, filed on Jun. 17, 2003.
(60) Provisional application No. 60/479,118, filed on Jun. 17, 2003.

(51) Int. Cl. B41M 5/00

(52) U.S. Cl. 428/32.34

(57) ABSTRACT

A coated paper, particularly useful as a photobase paper, includes a pigment coating on at least one side thereof wherein the pigment coating comprises aragonite precipitated calcium carbonate, hollow sphere pigment and, optionally high-aspect-ratio clay, with aspect ratio in the range of about 50 to about 100 and mixtures thereof. Methods for manufacturing the coated paper having a roughness of no more than 3 microns are also described.

### CROSS REFERENCE TO RELATED APPLICATIONS

This application claims the benefit of U.S. Provisional Application No.60/478,991, filed Jun. 17, 2003, which is related to U.S. Provisional Application No. 60/479,119, entitled “SMOOTH BASE STOCK COMPOSED OF NONSTANDARD FIBERS” and U.S. Provisional Application No. 60/479,118, entitled “BINDER SELECTION FOR COATED PHOTOGRAPHIC BASE STOCK.” The disclosures of these provisional applications are hereby incorporated by reference.

This application is related to contemporaneously filed U.S. application Ser. No. ______, entitled “SMOOTH BASE STOCK COMPOSED OF NONSTANDARD FIBERS” and U.S. application Ser. No. ______ , entitled “BINDER SELECTION FOR COATED PHOTOGRAPHIC BASE STOCK.” The disclosures of these applications are hereby incorporated by reference.

### FIELD OF THE INVENTION

The present invention relates to photographic base stock and, more particularly, to a photographic base stock comprising a pigment coating which exhibits improved smoothness.

Currently, there are several methods for producing photographic images. Silver halide-based photography and ink jet printing are two of the most frequently used methods for producing photographic images. Both methods depend on a highly smooth base paper on which to apply a functional coating. In the case of silver halide photography, the base paper is covered with a plastic film which in turn is covered with photosensitive coating layers. In the case of ink jet photo production, a high quality ink jet receptive coating is applied to the surface of a smooth base paper. The smoothness of the base paper is critical to the smoothness of the final product, and therefore, the quality of the photographic image produced.

U.S. Pat. No. 6,482,581 describes a photographic printing paper provided on at least a topside with a pigmented coating based on clay and/or other pigments to provide a surface roughness of 1 μm or less. The amount of clay is limited to less than 3.3 g/m² to maintain desired whiteness of the finished sheet.

U.S. Pat. Pub. No. 2001/0026869 describes using a narrow particle size pigment to improve smoothness of support materials for recording materials. The objective is to cover the roughness of the basesheet with a fixed amount of coating (coat weight). The potential benefit of the narrow particle size pigment is in increased coating bulk, giving improved coverage of basesheet roughness at a given coat weight. However, this benefit is only obtainable if the entire pigment system has a narrow particle size distribution. If a conventional clay or carbonate is used in conjunction with the narrow particle size pigment, the overall pigment particle size distribution is no longer narrow, and the benefits do not occur.

### SUMMARY OF THE INVENTION

In accordance with one aspect of the present invention, a coated paper is described having pigment coating on at least one side thereof wherein the pigment coating comprises aragonite precipitated calcium carbonate and hollow sphere polystyrene pigment. The pigment coating may also contain a high-aspect-ratio clay with aspect ratio in the range of about 50 to about 100. The pigment coating may be applied to provide a coat weight of from about 4 to about 15 lb/3300 ft², more particularly from about 8 to 10 lb/3300 ft².

The pigment coating in accordance with a particular embodiment of the invention may comprise aragonite precipitated calcium carbonate blended with hollow sphere polystyrene pigment wherein the hollow sphere polystyrene pigment is present in an amount of from about 5 to 25 parts (about 5 to 25%), more particularly 15 to 20 parts (about 15 to 20%), by dry weight based on total pigment weight. In accordance with other aspects of the invention, the pigment coating may comprise high aspect ratio clay with an aspect ratio of from about 50 to about 100 blended with aragonite precipitated calcium carbonate wherein the high aspect ratio clay is present in an amount of from about 5 to 25 parts (about 5 to 25%), more particularly 10 to 15 parts (about 10 to 15%), by dry weight based on total pigment weight. More specifically, in certain embodiments of the invention, the pigment coating may comprise hollow sphere polystyrene pigment, high aspect ratio clay and aragonite precipitated calcium carbonate wherein the hollow sphere polystyrene pigment is present in an amount of from about 5 to about 25 parts (about 5 to 25%), more particularly about 20 parts (about 20%), the high aspect ratio clay is present in an amount of from about 5 to about 25 parts (about 5 to 25%), more particularly about 12 parts (about 12%) and the aragonite precipitated calcium carbonate is present in an amount form about 50 to about 90 parts (about 50 to 90%), more particularly about 68 parts (about 68%), by dry weight based on total pigment. In accordance with another aspect of the present invention, the pigment coating is substantially free of clay.

The pigment coating may include a binder present in the pigment coating composition at from about 8 to about 30% by weight of the dry coating. The pigment to binder ratio may range from about 100:15 to about 100:40, more particularly from about 100:20 to about 100:30. In accordance with certain aspects of the present invention, the binder includes an acrylic binder. The acrylic binder may be selected from the group consisting of acrylic esters, modified acrylic esters, acrylic ester co-polymers, modified acrylic ester co-polymers and mixtures thereof.

A method for producing a coated paper for use in forming a recording material is also disclosed. The method includes the steps of providing a raw base stock and coating the raw base stock on at least one side with a pigment coating composition comprising aragonite precipitated calcium carbonate, hollow sphere polystyrene pigment and, optionally, high-aspect-ratio clay, with aspect ratio in the range of about 50 to about 100. The coated paper may further be subjected to a smoothing operation to provide a coated paper having a roughness of not more than about 1.5 micron Ra.

A support material for an image forming system is also provided. The support material includes a base stock having a pigment coating comprising aragonite precipitated calcium carbonate, hollow sphere polystyrene pigment, and, optionally, high-aspect-ratio clay, with aspect ratio in the range of about 50 to about 100 on at least one side thereof and an image forming or image receptive coating layer on at least one side of the coated paper wherein the image forming or image receptive coating is selected from the group consisting of a photosensitive emulsion, an ink jet receptive coating, a thermal dye recording layer and a pigment based ink receptive layer.

In accordance with specific embodiments of the invention, the support material further comprises a polymeric coating layer disposed between the pigment coating on the coated paper and the image forming or image receptive coating layer on one or both sides of the support material. The polymeric coating layer may be a polyolefin or polyester coating layer in accordance with certain aspects of the invention.

### BRIEF DESCRIPTION OF THE DRAWINGS

FIG. 1 is a graph showing average uncalendered roughness as a function of pigment type and binder level;

FIG. 2 is a graph showing average supercalendered roughness as a function of pigment type and binder level;

FIG. 3 is a graph showing uncalendered roughness (Ra) as a function of high-aspect-ratio clay and hollow sphere plastic pigment levels; and

FIG. 4 is a graph showing supercalendered roughness (Ra) as a function of high-aspect-ratio clay and hollow sphere plastic pigment levels.

### DETAILED DESCRIPTION OF THE INVENTION

All documents cited are, in relevant part, incorporated herein by reference; the citation of any document is not to be construed as an admission that it is prior art with respect to the present invention.

Coatings for photographic base paper typically must have a higher binder concentration than those used to coat other types of papers. This is because of the large amounts of fluid the sheet comes into contact with either in the silver halide photo development process or during ink jet printing of photographic images. Pigments optimized at typical binder levels, used for offset printing papers, may not perform well at the higher binder levels used for photo base papers.

One aspect of the present invention relates to a method of producing a highly smoothed base stock for photographic imaging by applying a coating containing one or more pigments found to be particularly useful in improving smoothness of the base stock. Examples of the pigments useful in the present invention include, but are not limited to, anisotropic particles in the form of needle-shaped aragonite precipitated calcium carbonate, high-aspect-ratio clay, low bulk density pigment in the form of hollow sphere polystyrene pigment and combinations thereof. In accordance with a more specific aspect of the present invention, a specific pigment formulation comprising a combination of these pigments is provided. By providing a particular range of concentrations of needle-shaped precipitated calcium carbonate, hollow sphere polystyrene pigment and high-aspect-ratio clay, the roughness of a coated photographic base paper can be minimized. In accordance with a particular embodiment of the invention a pigment coating containing from about 10 to about 14% high aspect ratio clay, from about 18 to about 22% hollow sphere polystyrene pigment and from about 65 to about 75% aragonite precipitated calcium carbonate based on total pigment weight can be used to minimize surface roughness. The present invention provides levels of roughness that are not typically attained using prior art techniques.

The hollow sphere pigment used in the present invention includes pigment particles made from a synthetic organic polymer or any inorganic shell-forming material such as glass or sodium silicate. Typically such microspheres have a diameter of approximately 0.3 to 15 and preferably about 1.0 micron. Such hollow synthetic organic pigment particles are known in the art and are commercially available from Rohm and Haas Corp. One example of a commercially available hollow sphere pigment that is useful in the present invention is sold under the trade designation HP-1055 from Rohm and Haas. Porous hollow plastic pigments available from Dow under the trade designation HS 2000NA are also believed to be useful when used as microspheres in the present invention. Hollow polymer particles which are useful in this invention may be made in accordance with and having the properties disclosed in U.S. Pat. Nos. 3,784,391; 4,798,691; 4,908,271; 4,910,229; and 4,972,000; and Japanese Patent Applications 60/223873; 61/62510; 61/66710; 61/86941; 62/127336; 62/156387; 01/185311; and 02/140272; U.S. Pat. Nos. 4,427,836;4,469,825; 4,594,363; and 4,880,842.

The high aspect ratio clay useful in the present invention includes those clays having an aspect ratio, diameter to thickness, of from about 50 to about 100. A particularly useful clay is a kaolin clay, Contour 1500, commercially available from Imersys.

Precipitated calcium carbonate generally has a crystal form of calcite, aragonite or vaterite. As the inorganic pigment used in the present invention, a precipitated calcium carbonate having a aragonite crystal form is preferable in view of providing increased smoothness to the resulting base stock. Aragonite forms crystals having a length/width ratio (hereinafter—“aspect ratio”) in the range between>1:1 and 100:1 of which a typical aspect ratio is 10, in which case the aragonite forms long, thin needles. Therefore, aragonite having a high aspect ratio may be denoted hereinafter—“acicular aragonite” or “needle-shaped aragonite”.

The needle-shaped aragonite precipitated calcium carbonate useful in the present invention includes those commercially available from Specialty Minerals. The aragonitic precipitated calcium carbonate pigments described in U.S. Pat. No. 5,861,209 may also be useful in the present invention.

The pigment coating composition of the present invention may further include binders and other pigments typically used in pigment coatings as would be known to those skilled in the art. Examples of pigments that may be included in the pigment composition include, but are not limited to, other calcium carbonate pigments, clay, titanium dioxide, aluminum silicate, magnesium silicate, magnesium carbonate, zinc oxide, talc, satin white, barium sulfate, calcium silicate, zinc hydroxide, etc.

Examples of binders that may be included in the pigment composition include, but are not limited to, styrene-butadiene polymers, acrylic polymers, styrene-acrylic polymers, vinyl acetate and ethylenevinyl acetate polymers.

In accordance with one aspect of the present invention, the binder used in the coating is an acrylic latex. Examples of acrylic latexes, include but are not limited to, acrylic esters, modified acrylic esters, acrylic ester co-polymers, and modified acrylic ester co-polymers. Examples of useful binders include Rhoplex B-15P, Rhoplex P-554, and Rhoplex 60-A. A particularly preferred acrylic latex is Rhoplex B15-P available from the Rohm and Haas Company. The binder is usually used in an amount of about 8% to 30% by weight, preferably about 15% to about 25% by weight, based on the total solids content of the coating. In accordance with particular embodiments of the invention, the coating composition includes binders described in copending application Ser. No. ______ entitled “BINDER SELECTION FOR COATED PHOTOGRAPHIC BASE STOCK.”

The base stock of the present invention may be used in any image forming system in which a smooth base sheet is required to provide a high quality image. By way of example, it may be used in conjunction with photosensitive emulsions, water or pigment-based ink receptive layers, thermal dye-recording layers, or other specialty coatings appropriate for a given imaging method. More particularly, a base stock produced in accordance with the present invention can be converted into photographic products or used to produce photographic ink jet products.

Base stock for papers that produce high quality images require exceptionally smooth surfaces. Fiber used in the manufacture of these papers is generally natural cellulose fiber, but synthetic fiber may also be used. The base stock can be produced on a Fourdrinier or cylinder paper machine. In accordance with one aspect of the present invention, a raw base sheet is formed using fibers as described in co-pending application Ser. No. ______ , entitled “SMOOTH BASE STOCK COMPOSED OF NONSTANDARD FIBERS.” Any conventional sizing and bonding agents can be used in manufacture of the raw base stock. The raw paper may contain pigments and filling agents such as clay, calcium carbonate or titanium dioxide, as well as additional auxiliary substances such as defoaming agents, optical brighteners and coloring agents. The basis weight of the raw base paper will typically be from about 50 to about 250 g/m², more particularly from about 100 to about 200g/m².

The pigment coating as described herein may be applied to the uncoated base stock using any conventional coating devices, such as a gate roll coater, a bill blade coater, an air knife coater, and the like. The pigment coating will typically be applied to provide a coat weight of from about 4 to about 15 lb/3300 ft², more particularly from about 8 to 10 lb/3300 ft².

After being formed and dried on the paper machine to form a web, or after applying the pigment coating to the base stock, final smoothness of the base stock or coated paper is generally achieved by subjecting the web or coated paper to various smoothing operations. One particularly useful method involves a densification process known as calendering, during which a paper web is passed between nips formed by multiple rolls stacked upon one another, creating pressure to compress the paper and make it smoother. Generally, the compression step is accomplished with a stack of four or more metallic rolls (U.S. Pat. No. 5,060,565). In such a stack, the nip load and compression force increase in each successive nip from the top down due to the weight of the rolls and whatever additional load force is applied. In U.S. Pat. No. 5,200,258, a process is described using a nip formed by two rolls of dissimilar material (i.e. metallic and a polymeric resin covered roll) followed by a nip formed by two metallic rolls. This is a process used for production of standard base stocks as well. In accordance with certain aspects of the present invention, the paper may be compressed by a succession of nips formed by either a polymeric resin covered roll and a metallic roll or by two metallic rolls. It is known in the art of calendering that a nip formed by a polymeric covered roll and a metallic roll will give improved fine scale smoothness to the web contacting the polymeric covered roll. A nip formed by two metallic rolls will improve large to medium scale roughness resulting from paper formation-related roughness. In accordance with a particular embodiment of the present invention, the smoothing operation involves passing the paper web or coated paper through a plurality of nips in a calender stack wherein the first nips are formed by polymeric covered rolls adjacent to metallic rolls and the last two nips are formed by pairs of adjacent metallic rolls. Therefore, the fine scale smoothness is improved initially with the large and medium scale smoothness improved in the last two nips. A means is employed to control nip pressures so calender roll weight and loading pressure are not the only factors in determining individual nip loads. The described calendering sequence allows a high level of smoothness without a blackening effect that can occur when paper is calendered through multiple metallic nips.

Coated paper in accordance with the present invention is advantageous due to the improvement in smoothness obtained using the described pigment coating composition. Smoother papers provide images of higher quality in most image forming operations. Smoothness of photobase paper is particularly important for generating high quality images. The surface roughness or Ra of the base stock or coated paper is a measure of relatively finely spaced surface irregularities on the paper. Ra represents the center line roughness of the base stock or finished paper. The surface roughness measurement provides an indication of the maximum variations over the surface of the paper. Lower Ra values indicate smoother base stock or coated paper.

In accordance with one aspect of the present invention, the paper is subjected to a smoothing operation to provide a base stock or coated paper having a roughness of from about 1.2 micron Ra to about 1.5 micron Ra. Calender loads typically range from about 1000 pli to about 1500 pli to produce base stock or coated paper having the desired smoothness. Ra is preferably 3.0 microns or less, more preferably 2.0 micron or less and most preferably 1.5 micron or less.

In accordance with another embodiment of the invention, a coated paper is provided having a pigment coating containing from about 20 to about 30% of an acrylic binder, from about 40 to about 80% of aragonite precipitated calcium carbonate and from about 15 to about 25% hollow sphere polystyrene pigment by weight based on the dry pigment coating.

In accordance with certain embodiments of the present invention, the pigment coated paper is further coated with a polymeric resin layer on one or both sides of the coated paper. The polymer film is typically applied to the coated paper by an extruding or laminating process although any method of coating the polymeric film to the base stock to provide a smooth surface can be used. One or more coating layers of polymer can be applied to the paper. The polymers useful in accordance with this aspect of the invention are not particularly limited provided the polymer is capable of being extruded, laminated or coated onto the paper base stock.

Polyolefin resins typically are used in producing a photographic support to which a photosensitive emulsion is applied. Polyolefin resins useful in forming the polyolefin resin layer include homopolymers of olefins such as low density polyethylene, high density polyethylene, polypropylene, polybutene, polypentene, copolymers of two or more olefins and mixtures thereof. Polymers of various densities and melt indices can be used. Polyester resins or films may also be used in producing a photographic support. The polymer resin layer may also include other additives such as pigments, amides, metal salts of aliphatic acids, antioxidants, brighteners, ultraviolet absorbers, etc. Titanium dioxide is frequently added to the polymer resin layer to improve sharpness and image resolution. U.S. Pat. No. 4,994,357 to Uno et al. describes various polyolefin coating compositions and the use of the compositions in producing photographic supports.

The polymer layer may be applied to provide a dry coat weight of from about 5 to about 30 lb/3300 ft², more particularly from about 15 to about 25 lb/3300 ft². The polymer layer can be extruded as a single layer or co-extruded as a multi-layer.

The present invention is illustrated in more detail by the following non-limiting examples.

### EXAMPLE 1

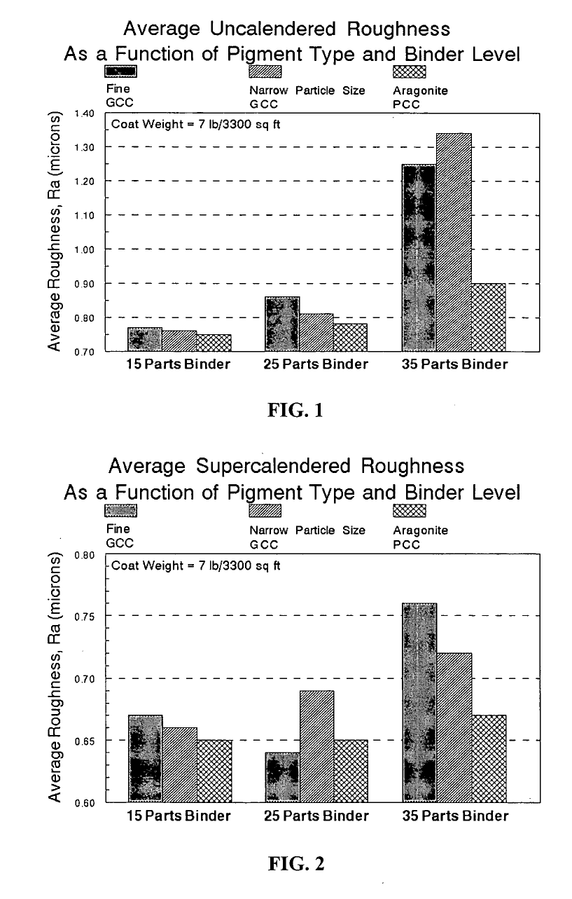

Three types of calcium carbonate pigments were compared. The first is a fine ground calcium carbonate with 90% of particles less than two microns in diameter (Hydrocarb 90 by Omya). The second pigment is a narrow-particle-size ground calcium carbonate (Covercarb HP by Omya). The third pigment is a needle-shaped aragonite precipitated calcium carbonate (Opacarb A40 by Specialty Minerals). The object was to compare the pigments for their ability to decrease the roughness of an uncoated photobase sheet. The formulations contained 85 parts calcium carbonate pigment, 15 parts hollow sphere polystyrene pigment, and 15, 25 or 35 parts of an acrylic based latex binder. (This corresponds to about 74 to 63% calcium carbonate pigment and 13 to 11% hollow sphere polystyrene pigment, and 13 to 26% acrylic based latex binder on a percent basis of total pigment coating). Coatings were applied to a 112 lb/3300 ft² photobase paper that had been steel-to-steel calendered. A bent blade coater setup was used. Coatings were applied at a coat weight of about 7 lb/3300 ft². FIG. 1 shows results for roughness testing performed on the coated, unsupercalendered paper. Roughness was measured using a Mahr-Feinpruf optical profilometer with an S8P processor. A cutoff length of 1 mm was used. The roughness value of the uncoated base sheet was 1.8 microns. FIG. 1 clearly shows that the comparative performance of the pigments depends greatly on the binder level of the coating. At the lowest binder level, performance differences among the pigments can be seen, but they are small. With 25 parts (about 20% of total pigment coating) binder, the differences among pigments can be seen more clearly. The narrow particle size ground calcium carbonate produced a lower surface roughness than the fine ground calcium carbonate. The aragonite precipitated calcium carbonate performed better than both ground calcium carbonates. At the highest binder level, which is the binder level typically used to prevent liquid penetration, the aragonite calcium carbonate clearly performs much better than either ground calcium carbonate. In this case, the narrow particle size pigment doesn't perform better than the standard ground calcium carbonate. If these coated sheets are supercalendered (FIG. 2), the differences in roughness are reduced, but at 35 parts (about 26% of total pigment coating) binder, the relative performance of the pigments is still clear.

### EXAMPLE 2

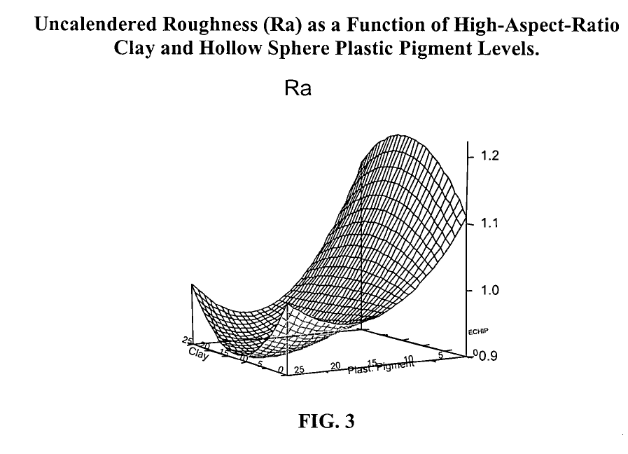

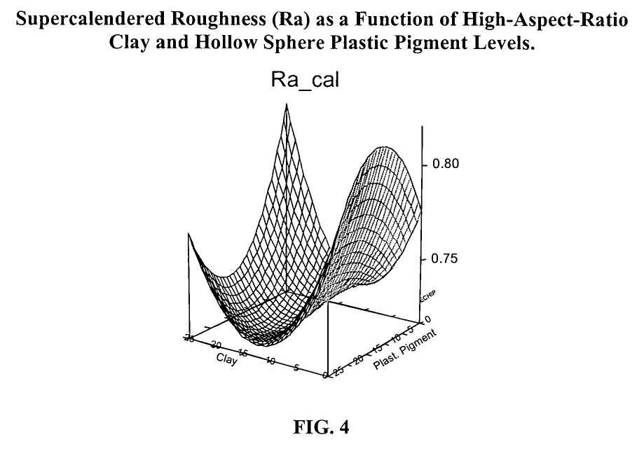

A designed experiment was conducted to optimize the levels of hollow sphere polystyrene pigment and high-aspect-ratio clay, in conjunction with aragonite precipitated calcium carbonate, to minimize the roughness of a coated photographic base paper. The high-aspect-ratio clay had an aspect ratio, diameter to thickness, of about 80. The coatings were applied to an uncoated photographic base paper. The pigments were bound using 25 parts (about 20%) acrylic latex binder and 3 parts (about 2%) starch. The Roughness was measured using a Mahr-Feinpruf optical profilometer with an S8P processor. The cutoff length was 1 mm. The test data was used, in conjunction with ECHIP statistical modeling software, to generate a mathematical model of the design space containing all levels of hollow sphere pigment and high-aspect-ratio clay between 0 and 25 parts (about 20%) pigment. The remaining pigment portion was made up of aragonite precipitated calcium carbonate (between 50 and 100 parts (between about 40 and 80%)). A partial cubic mathematical equation was used to model the data. The three-dimensional representation of that model is shown in FIG. 3 for the unsupercalendered roughness. The X-axis shows hollow sphere pigment levels between 0 and 25 parts (about 20%). The Y-axis shows high-aspect-ratio clay levels between 0 and 25 parts (about 20%). The Z-axis shows measured surface roughness in microns. The graph shows the roughness decreases as the level of high-aspect-ratio clay or hollow sphere pigment increases, up to a point. The graph shows an optimum combination of pigments, to produce minimum roughness, to be approximately 12 parts (about 9%) high-aspect-ratio clay, 20 parts (about 16%) hollow sphere pigment and 68 parts (about 53%) aragonite precipitated calcium carbonate. For supercalendered roughness (FIG. 4), the minimum roughness was achieved with approximately the same proportion of pigments. Parts are per 100 parts pigment and percentages are based on the total dry weight of the pigment coating.

Having described various aspects and embodiments of the invention and several advantages thereof, it will be recognized by those of ordinary skills that the invention is susceptible to various modifications, substitutions and revisions within the spirit and scope of the appended claims.

1. A method for producing a coated paper for use in forming a recording material comprising the steps of:
providing a base stock and
coating the base stock on at least one side thereof with a pigment coating composition comprising aragonite precipitated calcium carbonate, hollow sphere pigment and a binder to produce a coated paper.

2. The method of claim 1 wherein said coated paper further comprises high-aspect-ratio clay, with aspect ratio in the range of about 50 to about 100.

3. The method of claim 1 wherein the pigment coating coat weight is from about 4 to about 15 lb/3300 ft².

4. The method of claim 1 wherein the pigment coating comprises from about 40 to about 80% aragonite precipitated calcium carbonate and from about 15 to about 25% hollow sphere pigment by dry weight based on total pigment coating.

5. The method of claim 4 wherein the pigment coating further comprises from about 20 to about 30% of an acrylic binder based on total pigment coating.

6. The method of claim 5 wherein the binder comprises a styrene-acrylic binder.

7. The method of claim 1 wherein the pigment coating is substantially free of clay.

8. The method of claim 1 wherein the binder is present in the pigment coating composition at from about 8 to about 30% by weight of the dry pigment coating.

9. The method of claim 8 wherein the pigment to binder ratio is within the range from about 100:15 to about 100:40.

10. The method of claim 8 wherein the pigment coating comprises an acrylic binder selected from the group consisting of acrylic esters, modified acrylic esters, acrylic ester co-polymers, modified acrylic ester co-polymers and mixtures thereof.

11. The method of claim 1 wherein the coated paper has a surface roughness of not more than about 2.0 micron Ra.

12. The method of claim 1 wherein said hollow sphere pigment comprises a hollow sphere polystyrene pigment.

13. The method of claim 1 further comprising:
subjecting the coated base stock to a smoothing operation to provide a coated paper having a roughness of not more than about 2.0 micron Ra.

14. The method of claim 13 wherein said smoothing operation comprises passing the coated base stock through a plurality of nips at a load of from about 1000 to about 1500 pli.

15. The method of claim 13 wherein said pigment coating comprises from about 20 to about 30% binder, from about 15 to about 25% hollow sphere pigment and from about 40 to about 80% aragonite precipitated calcium carbonate based on total pigment coating.

16. The method of claim 13 wherein said binder comprises an acrylic binder selected from the group consisting of acrylic esters, modified acrylic esters, acrylic ester co-polymers, modified acrylic ester co-polymers and mixtures thereof.

17. A support material for an image forming system comprising a coated paper wherein the coated paper comprises:
a base paper having a pigment coating on at least one side thereof wherein the pigment coating comprises aragonite precipitated calcium carbonate and hollow sphere pigment; and
an image forming or image receptive coating layer on at least one side of the coated paper wherein the image forming or image receptive coating is selected from the group consisting of a photosensitive emulsion, an ink jet receptive coating, a thermal dye recording layer and a pigment based ink receptive layer.

18. The support material in accordance with claim 17 wherein the support material further comprises a polymeric coating layer disposed between the pigment coating on the coated paper and the image forming or image receptive coating layer on one or both sides of the support material.

19. The support material in accordance with claim 18 wherein the polymeric coating layer comprises a polyolefin or polyester coating layer.

20. The support material in accordance with claim 18 wherein the pigment coating coat weight is from about 4 to about 15 lb/3300 ft².

21. The support material in accordance with claim 20 wherein the pigment coating comprises from about 40 to about 80% aragonite precipitated calcium carbonate and from about 15 to 25% hollow sphere pigment by dry weight based on total pigment coating.

22. The support material in accordance with claim 21 wherein the pigment coating further comprises from about 20 to about 30% of an acrylic binder based on total pigment coating.

23. The support material in accordance with claim 22 wherein the pigment coating comprises from about 10 to about 14% high aspect ratio clay, from about 18 to about 22% hollow sphere polystyrene pigment and from about 65 to about 75% aragonite precipitated calcium carbonate based on total pigment weight.

24. The support material in accordance with claim 21 wherein the pigment coating is substantially free of clay.

25. The support material in accordance with claim 20 wherein the pigment coating further comprises a binder present in the pigment coating composition at from about 8 to about 30% by weight of the dry pigment coating.

26. The support material in accordance with claim 25 wherein the pigment to binder ratio is within the range from about 100:15 to about 100:40.

27. The support material in accordance with claim 25 wherein the pigment coating comprises an acrylic binder selected from the group consisting of acrylic esters, modified acrylic esters, acrylic ester co-polymers, modified acrylic ester co-polymers and mixtures thereof.

28. The support material in accordance with claim 20 wherein the support material has a surface roughness of not more than about 2.0 micron Ra.

29. The support material in accordance with claim 28 wherein the pigment coating comprises:
from about 10 to about 14% high aspect ratio clay, from about 18 to about 22% hollow sphere polystyrene pigment and from about 65 to about 75% aragonite precipitated calcium carbonate based on total pigment weight; and
from about 15 to about 25% of an acrylic binder by weight of the dry pigment coating.
